(19) United States
(12) Patent Application Publication
(10) Pub. No.: US 2002/0177985 A1
(43) Pub. Date: Nov. 28, 2002

(54) Computer system and method for radial cooled bucket optimization

(76) Inventors: Joseph Anthony Kraft, Simpsonville, SC (US); Praveen Krishna Ir Pillai, Kollam (IN); Robert Alan Brittingham, Piedmont, SC (US)

Correspondence Address: BANNER & WITCOFF, LTD., ATTORNEYS FOR GENERAL ELECTRIC, 1001 G. STREET, N.W., ELEVENTH FLOOR, WASHINGTON, DC, 20001-4597, US

(21) Appl. No.: 09/839,610

(22) Filed: Apr. 23, 2001

(51) Int. Cl. G06G 7/48

(52) U.S. Cl. 703/7

(57) ABSTRACT

A computer system and method optimizes the heating exchanging geometry of a radial cooled bucket for a turbine engine. The computer system enables rapidly prototyping and evaluations of different radial cooled bucket configurations. The computer system includes a simulator and an optimizer. The simulator forms an analytical model of the bucket and executes a simulation of a thermal environment within the engine producing a predicted performance parameter for the model. The optimizer compares the performance parameter to a baseline criterion. If the performance parameter does not match the baseline criterion the optimizer automatically indexes a variable of defining the geometry.

### BACKGROUND OF THE INVENTION

The present invention relates to a radial cooled bucket of a turbine engine, more particularly, the present invention relates to an integrated computer system and method for three-dimensional radial cooled bucket performance prediction and optimization.

Manufacturers of advanced turbine engines seek to design and develop engines with reduced life cycle cost. Life cycle cost control is a measure of efficiency for manufacturers and users of gas turbine engines. The life cycle cost can relate to many factors effecting cost such as, the initial design and engineering costs, and other cost factors incurred during the life of a gas turbine engine. Thus, any improvement that can reduce life cycle costs is a valuable one. One method of reducing life cycle cost is to improve the efficiency of engineering analysis and cycle time to develop new airfoil designs. A second method to reduce life cycle cost is to increase the time period for between periodic inspections for the installed airfoils. Users of advanced turbine engines, particular in the power generation industry, seek certain guarantees of the life/efficiency of their engines. Accordingly, there is a need for manufacturers of such engines to provide robust, highly optimized new designs to mitigate warranty charges over a long period of time. Therefore, there is a need to quickly evaluate many different airfoil designs to understand the transfer function driving the life of the part.

There is also a need to increase gas temperatures within a turbine engine to improve efficiency and performance of the engine. In general, the temperature of the airfoil is a function of the temperature of the gases flowing through the gas turbine and also as a function of heat transfer occurring between the airfoil and the gases. The ability of the airfoil to withstand to the very high temperature operation has been one factor in restricting improvements into increasing the efficiency of gas turbine engine. The high operating temperatures may reduce the life of the airfoil, measured in operating hours of the turbine engine. Accordingly, there is a need to provide airfoils with optimized cooling hole geometry to help increase the life of the airfoil. Since the search for improved the efficiency of turbine engines continues by further increasing the gas temperature, new optimized designs of the internal cooling geometry are needed to increase heat transfer and extend the life of the airfoil.

It is a very difficult, tedious, long, and costly process to determine the inside cooling configuration of an airfoil to meet design criteria to increase the efficiency. For many years, designers of turbine buckets would specify a particular airfoil shape, and the typical operating flow path temperatures. A team of designers would then need to determine how to prevent a turbine bucket from excessively heating or cracking at the same time withstand the high operating temperatures. Accordingly, the design cycle time for one configuration of a typical radial cooled bucket could range between 60 to 100 hours, which would be even greater after factoring the man-hours for the team. This design cycle time increases the life cycle cost of the gas turbine engine and makes it difficult to meet critical production schedules.

Designers have used some engineering tools to reduce the cycle time, such as finite element analysis or methods. Finite element analysis is a numerical method for determining the physical behavior of engineering structures in relation to physical forcing functions. A finite element model includes building blocks of elements and nodes. The elements divide a structure into small discrete units. The smaller the unit the finer the analysis. A typical structure undergoing analysis may include thousands of elements. Each element is related to a standard set of equations for solving a physical characteristic. Each element is interconnected to adjacent elements to form a mesh with nodes at the intersections of the elements. At each node, certain boundary conditions are applied for approximating the physical environment of the structure under evaluation. The mesh with the set of equations and boundary conditions are analyzed by the finite element method.

Finite element analysis is not without some problems. First, the mesh creation is highly dependent on the skill of the user which can lead to inconsistent results between analysis of the same structure by different users. Second, in creating a mesh, the most common error is improper application of loads and boundary conditions on the mesh. This can lead to erroneous results from the simulation runs. As a result, a user must spend significant time to check the boundary conditions at each node. A radial cooled bucket has a complex geometry having many curves and lines. The finite elements used to define a mesh for a bucket have edges defined by straight lines. These edges attach to the curved lines of the solid model. The edges must be attached together in sufficiently fine resolution to create the curved lines of the solid model. A problem arises when trying to create finite element mesh to approximate the curved geometry. Conventionally, too few elements can lead to an erroneous solution and too many elements increases computer processing time. All of these problems increase the life cycle costs by increasing the processing time or cycle time.

Thus, what is needed is a computer system and method of predicting the performance of a radial three-dimensional bucket to overcome the problems of conventional finite element analysis and significantly reduce life cycle costs.

### BRIEF SUMMARY OF THE INVENTION

Broadly, the embodiments of the present invention advantageously enable a user to rapidly prototype and evaluate a number of different radial cooled bucket configurations to determine how small changes in the bucket will impact a particular physical parameter.

The present invention solves the problem in the art by providing a computer system for optimizing a radial cooled bucket configuration for a turbine engine. The computer system comprises a simulation module and an optimizer tool. A dynamically configurable analytical model is generated from a solid model of the bucket for the turbine engine. In addition, the simulation module executes a simulation of a thermal environment within the turbine engine to produce a predicted performance parameter for the analytical model. The optimizer tool compares the performance characteristic to a baseline criterion by applying a maximization/minimization procedure of the difference between characteristic and criterion. The computer system automatically modifies at least one geometry variable for the internal cooling geometry of the bucket and outputs a plurality of attribute data of the internal cooling geometry.

Briefly, a method of as applied to radial cooled bucket optimization analysis generally is provided. First, a solid model of a bucket is provided to a finite element analysis module. Second, a plurality of radial cooling passageways are automatically formed within the bucket solid model by the finite element module. Third, a finite element mesh is automatically generated for the external and internal geometries of the solid model. The finite element mesh is created to accurately fit the geometry of the solid model to obtain accurate results while reducing the number of elements to save computer processing time. In addition, finite element mesh errors are eliminated.

Fourth, a plurality of boundary conditions are generated and are mapped to the finite element mesh to generate an analytical model. The method advantageously uses consistent node definition for the external geometry mesh so that the boundary conditions are generated only once to reduce computational processing time. Fifth, a heat transfer analysis is performed on the analytical model to produce a predicted response to the boundary conditions and internal geometry. Sixth, the predicted response is compared to a predetermined criteria for optimization of a given bucket solid model with radial cooling passageway. If further optimization is warranted, seventh, the internal geometry is adjusted, and a new finite element mesh is generated for the updated geometry. After each optimization iteration, the processing of the boundary conditions and a heat analysis are performed. When a desired optimized geometry is determined the attribute data is stored and the process completed.

Further, the invention advantageously fulfills the continual search for manufacturers of such gas turbine engines to provide highly optimized new designs of the internal cooling geometry to increase heat transfer, and to reduce or eliminate airfoil problems due to high operating temperatures. Also, the present invention fulfills the need to determine increases gas temperatures within a turbine to improve efficiency and performance of a gas turbine engine with associated buckets.

### BRIEF DESCRIPTION OF THE DRAWINGS

FIG. 1 is a system block diagram schematically illustrating of an embodiment of a computer system architecture;

FIG. 2 is a flow chart representing an embodiment of the method of the present invention;

FIG. 3 is a flow chart of an embodiment of a subroutine method creating a solid model of a radial cooled bucket and creating a finite element mesh;

FIG. 4 is a system block diagram of an alternative embodiment of a computer system;

FIG. 5 is a perspective view of a three-dimensional solid model of a bucket for a gas turbine engine;

FIG. 6 is a perspective view of a solid model of the airfoil portion of the bucket shown in FIG. 5;

FIG. 7 is a perspective view of a representation of a plurality of radial cooling passageways for the bucket shown in FIG. 5;

FIG. 8 is a perspective view of a representation the modeled bucket shown in FIG. 6 having the radial cooling passageways shown in FIG. 7 generated therein;

FIG. 9 is a perspective view of a representation of the modeled bucket shown in FIG. 8 after section volumes have been created;

FIG. 10 is a perspective view of an external finite element mesh of an external surface area of the modeled bucket of FIG. 8;

FIG. 11 is a perspective view of an internal finite element mesh of inside surfaces of the radial cooling passageways shown in FIG. 8;

FIG. 12 is a perspective view of finite element meshes of the section areas of the modeled bucket shown in FIG. 8;

FIG. 13 is a perspective view of completed finite element mesh including the internal volume meshes shown in FIGS. 10-12;

FIG. 14 is a perspective view of a tip of the mesh shown in FIG. 13 illustrating finite element shapes and interconnection of a radial cooling passageway;

FIG. 15 is an enlarged view of FIG. 14;

FIG. 16 is a perspective view of a tip of the mesh shown in FIG. 13 illustrating finite element shapes of the finite element mesh;

FIG. 17 is a schematic cross-section of a radial cooling passageway defining a turbulated form of the passageway;

FIG. 18 is a chart showing exemplary P/A ratios after a heat transfer analysis simulation;

FIG. 19 is a chart showing exemplary section bulk temperatures after a heat transfer simulation;

FIG. 20 is a chart showing exemplary maximum temperatures per section after a heat transfer simulation; and

FIG. 21 is a chart showing exemplary thermomechanical factors after a heat transfer simulation.

### DETAILED DESCRIPTION OF THE INVENTION

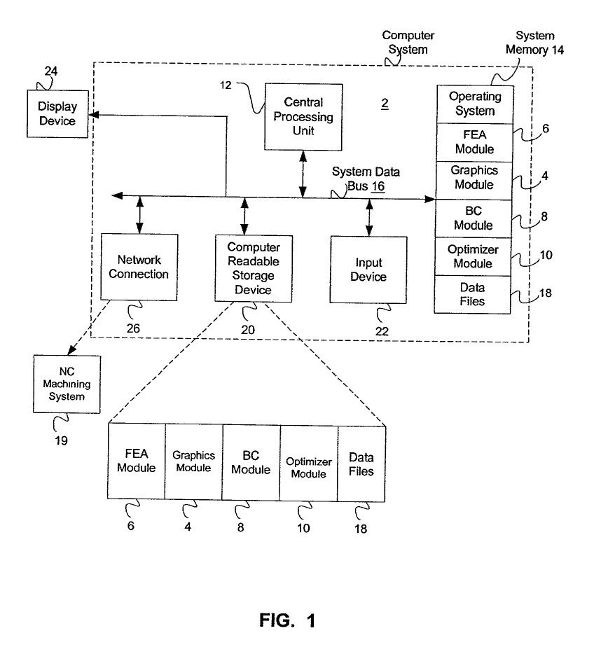

Referring to FIGS. 1-17, an integrated computer system 2 and method for three-dimensional radial cooled bucket performance analysis is illustrated. An overview of computer system architecture 2 for radial cooled bucket analysis is illustrated schematically in FIG. 1. Computer system 2 comprises several software or program procedural components that execute program instructions for specific purposes. The program procedural components includes some or all of the following modules—a graphics module 4, a finite element analysis (FEA) module 6, a boundary condition module 8, and an optimizer module 10.

A brief overview of the function of each module is described below. Graphics module 4 generates a three-dimensional solid model of a bucket. Finite element analysis module or simulator system 6 performs numerical calculations to simulate the environment of a bucket within a gas turbine for predicting a physical response to the internal radial cooling geometry. Boundary condition module 8 generates a specific set of data for approximating the physical environment of the radial cooled bucket under evaluation. Computer system 2 also comprises an optimizer module 10 that includes an optimization algorithm for finding the best design for a radial cooled bucket under evaluation. An operating system of computer system 2, may include variations of the standard system such as UNIX®, WINDOWS® and WINDOWS NT®, or even LINUX®. Each component of computer system 2 will be described in detail herein.

Shown in schematically in FIG. 1, computer system 2 may be a general-purpose computer, such as a mini-computer, a high-speed computer workstation, a personal computer, or a laptop computer. Hardware components of computer system 2 include a central processing unit 12, a system memory 14, and a system bus 16 that couples various computer system components. Central processing unit 12 may be one or more suitable general-purpose microprocessors used in a conventional computer. The system bus 16 may be any of several types of conventional bus structures. System memory 14 includes computer readable code in the form of read only and random access memory. System memory 14 is used to store a portion of finite element analysis (FEA) module 6, graphics module 4, boundary condition module 8, optimizer module 10, and related data files 18.

Computer system 2 further includes a computer readable storage device 20 that may comprise a magnetic disk drive, or alternatively, an optical disk drive such as a Compact Disk ROM, or a DVD drive. Storage device 20 and associated computer-readable media provide nonvolatile storage of computer readable code and instructions for execution on the computer system. Graphics module 4, finite element analysis module 6, boundary condition module 8, optimizer module 10, and related data files 18 are stored on storage device 20.

If desired, a user may enter commands and information into computer system 2 through an input device 22 such as a keyboard, a pointing device, or a graphics tablet. A display device 24, such as a monitor is also connected to the system bus by conventional methods. In addition to the monitor, computer system can 2 include other peripheral output devices (not shown), such as a printer.

If desired, computer system 2 may operate in a networked environment using a network connection 26 to one or more a destination clients such as a computer workstation or a network server. The networked environment may include a local area network (LAN), a wide area network (WAN), or a distributed network, such as the Internet including the World Wide Web.

Component attribute data is herein defined as a specific set of data elements that defines a three or two-dimensional representation of the geometry of a particular object. The terms “airfoil” or “bucket” attribute data comprise component attribute data as applied to a bucket of a turbine engine. Component attribute data comprises positional, dimensional and material property data. The positional and dimensional data comprise information relating to physical measurements relative to user specified Cartesian coordinate system of x, y, z-axes or directions, vectors, surface, and curve definitions. The attribute data also serves as final data for manufacturing the radial cooled bucket with computerized machining equipment.

The material property data comprises information relating to physical material properties of a user specified material, such as a particular metal, metal alloy, or other material. These material properties can include, but are not limited to, a weight density, a heat transfer coefficient, and a coefficient of thermal conductivity. These types of attribute data are known to one of ordinary skill in the art. The attribute data can be described in the Initial Graphics Exchange Specification (IGES) as data format for describing product design and manufacturing information in computer-readable form. IGES is commonly used for portability of data among various computer systems. Other data formats are contemplated to be used in the present invention.

A preprocessing phase is preformed in which computer system 2 uses a predetermined airfoil profile of the external geometry for a particular configuration. Preprocessing of the airfoil profile design with a hot to cold analysis is generally completed for producing attribute data of the bucket. Accordingly, the airfoil attribute data contains data for a cold or an unheated airfoil design. If desired, this functionality of preprocessing to determine the airfoil profile can be integrated within computer system 2.

Referring to FIG. 1, computer system 2, includes graphics module 4 having hardware and software for providing dimensional and material characteristics a bucket of a turbine engine or other parts. In the embodiment shown, graphic module 4 creates a set of bucket attribute data for use in finite element analysis module 2. The bucket attribute data is processed so that a representation can be illustrated in a three-dimensional model, commonly called a solid model. Graphics module 4 embodies the bucket attribute data in a computer readable code that can be stored on a nonvolatile computer useable storage medium, such as storage device 20. The graphics module is embodied by a system running computer-aided-design or engineering (CAD/CAE) and computer-aided-manufacturing (CAM) software that produces an IGES compatible format or any suitable data format for transmitting solid model definitions across different types of CAD/CAM/CAE systems. Nevertheless, suitable alternatives of the graphics module include, UNIGRAPHICS® software manufactured by UGS, INC. of Cypress Calif., and AUTOCAD® by Autodesk, Inc., or other alternative software.

A simulator system such as, finite element analysis module 6, includes hardware and software configured to generate a finite element mesh and perform numerical computations using a finite element analysis method. Finite element analysis module 6 receives the bucket attribute data from graphics module 4 or other source storing the data. The finite element mesh includes finite element units that interconnect at nodes. The finite element mesh is embodied in a computer readable code that can be stored in computer readable code in devices such as storage device 20 or system memory 14. Finite element analysis module 6 predicts physical performance parameters or characteristics from a thermal or heat transfer simulation of an analytical model, being dynamically configurable, having a specific set of boundary conditions applied to the nodes of the finite element mesh.

Finite element analysis module 6 advantageously implements an algorithm to control unchanging the node definition on the finite element mesh for the external geometry of the bucket under evaluation. Alternatively, a finite element mesh generator executes the algorithm for node definition code. The algorithm enables the internal cooling geometry of the bucket to be varied without constantly changing the external mesh definition. In contrast to conventional methods, the present invention advantageously enables a set of external boundary conditions to be generated once and employed for each change in the internal geometry of the bucket under evaluation. Accordingly, the present invention significantly reduces the associated processing time and cost over conventional systems. In contrast, in conventional systems, a change in the internal geometry normally causes new external boundary conditions to be regenerated.

Finite element analysis module 6 is embodied by a computer system running an appropriate finite element simulation software having thermal analysis capability such as, ANSYS® manufactured by Ansys, Inc. located in Canonsburg, Pa. Other finite element simulation software includes NASTRAN® by The MacNeal-Schwendler Corporation, ALGOR® by Algor, Inc. Pittsburgh, Pa, ABAQUS®, by Hibbitt, Karlsson & Sorensen, Inc., Pawtucket, R.I., ADINA™ by ADNIA R&D, Inc. of Watertown, Mass. or other similar type of systems.

Computer system 2 further includes boundary condition module 8 having hardware and software to generate a specific set of boundary conditions for the nodes of the finite element mesh. The boundary conditions are generated for the external and internal finite element mesh. Boundary condition module 8 implements a secondary flow solver and maps a one-to-one correspondence of the boundary conditions to the nodes. The secondary flow solver for compressible fluids is a technical approach used in fluid mechanics analysis in the electrical power generation and turbo-equipment machinery industries. One type of secondary flow solver performs a two-dimensional fluid mechanics analysis to provide a heat transfer coefficient, and internal temperatures for the nodes in the internal finite element mesh. Software for implementing a secondary flow solver is widely available in the power generation industry. Some companies have created their own flow solver, such as the YFT solver used by the Assignee of this application. In addition, the boundary condition module includes software for mapping a one-to-one correspondence between the nodes of the finite element mesh and generated boundary conditions. One type of software for this purpose is called a boundary condition mapper.

The external boundary conditions, such as, the external heat transfer coefficient (HTC) and corresponding surface temperature (T), are functions of the external airfoil pressures, temperatures and mach numbers (airspeed above the speed of sound). For example, after the preprocessing period, the external airfoil pressures, temperatures and mach numbers are specified. This data can calculated with software called Gas H Suite of Tools (GHST) owned by the Assignee of this application. This data is saved and then can be inputted into various types of fluid mechanics software to obtain the HTC and T. One example of software for this purposes is System for Integrated Engineering and Thermal Analysis (SIESTA) owned by the Assignee of this application which can obtain HTC and T. One feature of the SIESTA program, includes using standard heat transfer formulas with input data from GHST to determine HTC and T on a surface area. If desired, other methods can be used to generate the boundary conditions. It should be recognized the external boundary conditions can be calculated by technical approaches used in fluid mechanics analysis in the electrical power generation and turbo-equipment machinery industries by one of ordinary skill in the art.

With reference to FIG. 1, optimizer module 10 includes hardware and software that cooperates with graphics module 4, finite element analysis module 6, and boundary condition module 8. Optimizer module 10 determines the best configuration of the radial cooled bucket under evaluation for a given set of boundary conditions. This is accomplished by using a numerical optimization technique to modify the internal geometry of the solid model. The optimization technique uses an iterative approach for satisfying a predetermined criteria based on a predicted physical response of the analytical model. Optimization involves defining and then maximizing/minimizing an objective function relating to the radial cooling bucket. In this embodiment, the objective function includes factors that affect the life of a radial cooled bucket alternatively. Other kinds of optimization techniques can be used, such as quadratic programming, genetic algorithm, and method of feasible directions. It is also contemplated that using two or more of the aforementioned techniques can provide a more refined solution. The selection of optimization technique can depend on complexity of the problem.

Optimizer module 10 seeks to maximize low cycle fatigue life, oxidation erosion life, and bulk creep life associated with the bucket under evaluation. Maximization is accomplished by act of repeatedly varying one or more design variables through a number of iterative steps to converge on a desired solution. Alternatively, the optimizer can perform recursive steps by narrowing or increasing the value of the design variables. The difference between the internal temperature, low cycle, fatigue, erosion and bulk creep in the model is compared to the baseline criteria.

The geometry variable or variables altered for optimization are parameters functioning to control the internal geometry of the bucket, such as the x, y, z-position of each radial cooling passageway, the number of cooling passageways, and the geometric structure of each cooling passageway, such as the diameters, but it is not limited to the aforementioned variables. To reach a solution in a reasonable number of iterations, optimizer module 10 identifies an appropriate direction and magnitude of step for each iteration by changing the geometry or design variables accordingly. This can be applied for a turbulated or a non-turbulated cooling pathway in the shapes of the cooling pathway can be elliptical or circular. Optimizer module 10 can be embodied by a computer system operating computer-aided-optimization (CAO) software such as, ISIGHT® manufactured by Engineous Software, Inc. located in Research Triangle, N.C.

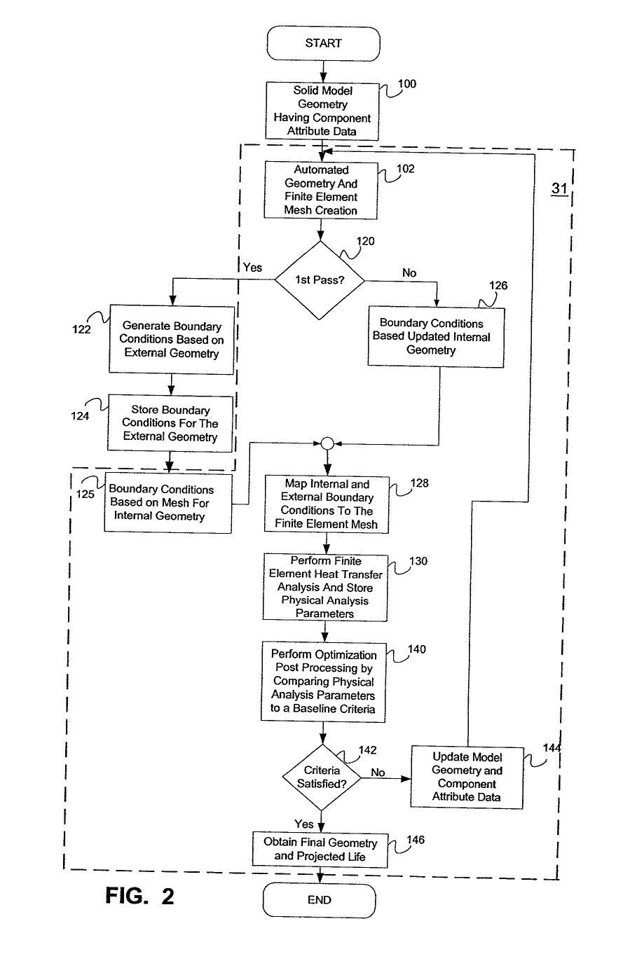

FIG. 2 illustrates a flow chart of an embodiment of a method implemented by computer system 2 for radial cooled bucket performance prediction and optimization. In step 100, a solid model of bucket comprises bucket attribute data of an existing bucket design on a fielded gas turbine engine or, alternatively, a new proposed design. Computer system 2 requests the graphics module to transmit the bucket attribute data to the finite element module. In addition, the computer system directs finite element analysis module 6 to initiate and receive the bucket attribute data.

In step 102, system flow passes to an automated geometry and a finite element mesh creation algorithm or agent. The steps of the algorithm 102 are illustrated in more detail in FIG. 3. In sum, algorithm 102 creates a solid model with radial cooling passageways and creates a finite element mesh of the solid model so that boundary conditions can be mapped to nodes in the finite element mesh. If desired, the user has the option of meshing and selecting external coating and thickness of the bucket.

In step 103, the algorithm invokes finite element analysis module 6 to perform the several Boolean operations to generate a plurality of internal radial cooling passageways or cylindrical holes based on data input files provided by the user. This step the user has specified a conditional internal cooling geometry (CICG) as a starting point for optimizer module. The Boolean operations includes several steps of subtracting the volume defined by each of the radial cooling passageways from the internal volume of the solid model of the bucket. The Boolean operations include commands such subtract, add, or join solid components. These operations are included in conventional solid modeling software.

With reference to step 103, the Boolean operations simulate drilling or casting of the passageways in an actual bucket. The cross-sectional geometry of the radial passageways, through a plane normal to a radial axis, can be either circular or elliptical. In addition, the internal radial passageways can be two types, a non-turbulated type having a continuous interior surface or, alternatively, a turbulated type having a finned interior surface. For non-turbulated types of passageways, the present invention employs user data files defining a root position of the center of the each radial passageway at the bottom portion and an airfoil radial tip position at the top portion of the bucket. Because, a radius or diameter is defined for each passageway FEA module 6 generates a cylinder having that diameter extending between the root and the airfoil radial tip positions. Then, each cylinder is subtracted from the interior of the solid model of the bucket. Thus, a continuous interior surface is created that extends through the solid model of the bucket to simulate a non-turbulated passageway.

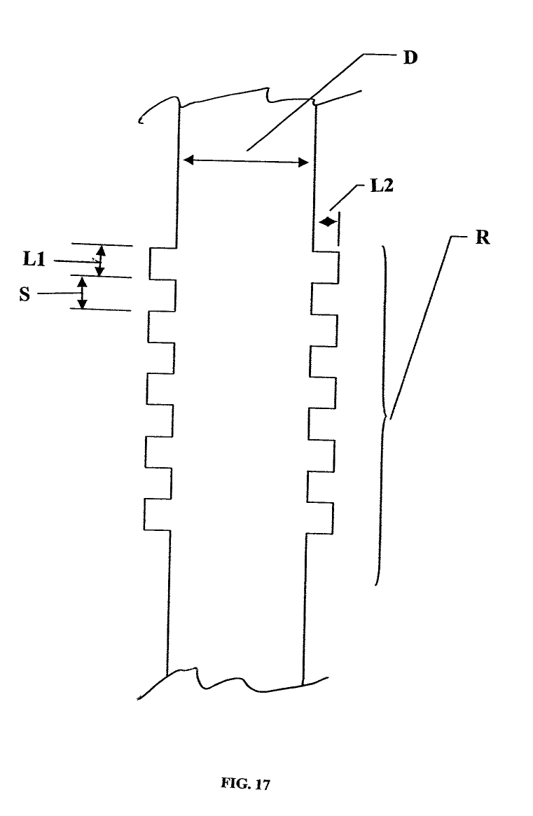

With reference to step 103, for turbulated types of passageways, a root and airfoil radial tip position of the centers of each passageway are defined. Then, the location of a turbulation region R is determined as a percentage of the length of the passageway. Fin-like projections are defined in turbulation region R such that additional volume is subtracted from the internal volume. FIG. 17 shows a general definition of a turbulation region R for a radial cooling passageway. The diameter D of a passageway is designated in the non-turbulated region. The user designates turbulation region R and various dimensions L1, L2 and spacing S between the fin-like projections. For the turbulated type passageway or corresponding region R, an effective diameter, similar to D, may be calculated using a traditional equation and then cylinders are created and are subtracted from the base volume. An effective area is calculated and a cylinder with that effective diameter is created.

Then in step 104, the algorithm, performs several geometric property calculations for later use during an optimization step. This is accomplished by segmenting the internal volume into several sections. The heights of the sections can be defined as the percent of the airfoil height. The specific section volume, area, and a “pull” parameter relating to a centrifugal force are automatically calculated and stored in variable arrays for future optimization comparisons. In addition, a “P/A” ratio in weight per area or lbs/in² is automatically calculated and stored in a data array structure for later use in bulk creep evaluations during the optimization comparisons. Also the bucket may have a shroud or bucket cover. The user has the option of adding a tip shroud volume and other characteristics from which the code will automatically calculated the shroud “pull” in weight per area such as pounds per square inches.

In step 106, the algorithm determines a uniform three-dimensional element size based on the interior volume of the particular solid model and number of desired finite elements. There are number of ways to create the finite element mesh. One approach is to use tetrahedral elements and segment the internal volume by sequentially meshing the section volumes. In this approach, the mesh generator uses the tetrahedron element size. The element size determination is accomplished by using a tetrahedron element type and calculating the volume of the tetrahedron using a standard volume equation.

In step 108, the element size is provided to a finite element mesh generator of finite element analysis module 6. Alternatively, the finite element mesh generator can be a separate application program that operates outside of finite element analysis module. The algorithm operates with the mesh generator to apply an adaptive curve fitting technique for creating a finite element mesh that fits the curved geometry of the solid model. Specifically, the algorithm selects a line that defines the external surface of the solid model and calculates the length of the line. From the desired number of elements and standard element size, a calculation is performed that divides the line into divisions for uniform spacing of the element edges. Thus, there is balance between the number elements and amount of processing time.

Then at step 110, the algorithm compares the number of divisions against the line to check for an approximation of the curve. In such, an even number of divisions provides for an improved approximation. A good curve fit approximation is generally defined as, a “fit” which retains the curvature effect so that it will minimize the volume loss due to the meshing and keeps the curvature shape. When performing a thermal analysis the surface areas are used due in part to convection/radiation occurring through the surface area. This curve fit along with the surfaces area of the exterior surfaces refines the value of the heat transfer occurring through that area. If the curve fit comparison is not a good approximation, then the number of divisions is sequentially increased by a predetermined factor, such as two (2) at step 112. If the curve fit comparison is a good approximation, then control passes to step 114.

System flow passes to step 114, in which the number of division is transmitted to the mesh generator. In this step, the number of divisions is used to “seed” the other curves of the solid model for future mesh creation as described below. This is analogous to copying the divisions to the other lines in the solid model.

System flow passes to step 116, in which the algorithm uses triangular elements to create a finite element mesh on the external surface of the solid model. This occurs in cooperation with the mesh generator. Alternatively, quadrilateral shaped elements may be used, in lieu of triangular elements. A general shape of a triangular element is an equilateral element. A quadrilateral has a square shape. Also the shape of a tetrahedron is that of an equilateral tetrahedron. These elements are created in the mesh generator within allowable warping limits used for meshes. The algorithm employs an unchanging node definition for the external mesh for advantageously reducing computational time associated with regenerating the boundary conditions. So irrespective of the changes in the internal geometry of the solid model, the external areas will have the same node numbering. This enables the external boundary conditions to be generated only once and can be reapplied again to the external mesh.

With reference to step 116, the approach taken in the algorithm is to keep the definition of the external surfaces and external finite element mesh unchanged. In addition, within the same step, the algorithm automatically selects the internal surfaces of the cooling passageways and in cooperation with the mesh generator applies a mesh having triangular shared elements. The adaptive curving fitting technique is used to retain a close approximation of the cross-sectional geometry of the cooling passageways. The system proceeds to apply a mesh of triangular elements to the areas of the section volumes in the internal portion of the solid model.

Control flow passes to step 118, in which the mesh generator creates a finite element mesh of the internal volume of the solid model. Due to the algorithm control over the size and number of elements, error elements are eliminated and the resulting finite element mesh will be of high quality. The quality of the mesh may be determined by the standard tests for checking the quality and the type of analysis being performed. One type of test is a Jacobean test used in finite element analysis. Accordingly, the algorithm advantageously enables a detailed analysis of the internal volume of the solid model in the heat transfer simulation without errors. Another approach is to simply use a free mesh option in the ANSYS® software or a combination thereof. If desired, in FEA module 6, brick type or cube-like elements may be used in lieu of tetrahedral elements with allowable warping limits. These brick elements can provide further refined calculations and reduce processing time. The final result of the algorithm is a completed finite element mesh defining the internal and external geometry of the solid model at step 119. If desired, based on the user-defined number of sections, the algorithm can automatically store two-dimensional meshed sections.

Once the finite element mesh is generated, system flow passes to step 120. In step 120, computer system 2 implements a decision step to determine whether an initial run of the radial cooled bucket solid model has occurred. This can be accomplished by defining an indexing variable that indexes for each update of the internal geometry of the solid model. If it is an initial run of the radial cooled bucket, then control passes to step 122, wherein an initial set of boundary conditions are created in the manner previously described in boundary condition module 8. The boundary conditions are based on the initial finite element mesh for the external geometry. In this step 122, the program flow enables an operator of computer system 2 to provide the external mesh definition having nodes numbers and Cartesian coordinates for each node as input data into the SIESTA program of boundary condition module 8. The SIESTA program is enabled to interpolate the HTC and T on the external geometry to specify them to the nodes. Then, at step 124, the boundary conditions for the external geometry are specified by heat transfer coefficient and temperatures at each node are transmitted to storage device 20 and are embodied in a computer readable data file for future use. At step 125 boundary conditions for the internal geometry are generated.

Referring back to the decision step 120, if the initial run has indeed occurred, then control passes to step 126, wherein the boundary conditions are regenerated for an updated internal finite element mesh. The boundary conditions for the external finite element mesh are not regenerated, because they were saved on the initial run.

After decision step 120, the internal and external boundary conditions are mapped to the nodes of the finite element mesh at step 128. It should be recognized that an analytical model of the radial cooled bucket is formed by the finite element mesh. This model is designed to be dynamically configurable by changing the geometry variables for the internal cooling geometry. A heat transfer simulation is performed using finite element analysis module 6, at step 130. It should be recognized that the heat transfer analysis provides several predicted physical parameters that the actual bucket may experience during operation. These predicted physical parameters are stored for future use including, later optimization of the internal geometry of the radial cooled bucket.

Post processing of the physical parameters generated from the analytical model is performed in step 140. The average temperatures generated for each section volume are stored in a data file with the previously calculated and stored P/A ratios. The maximum temperature per each section volume is also calculated to determine predicted oxidation erosion. A thermomechnical factor (TMF) parameter is used to compare a low cycle fatigue (LCF) capability of the particular internal geometry of the bucket. The TMF parameter is advantageously determined from the heat transfer analysis and avoids performing a separate structural analysis run conventionally required for finding the low cycle fatigue. The TMF parameter is calculated from a standard thermal strain equation:

δ=α(tₘₐₓ−tₐᵥₑ),

Where

δ—is the thermal strain;

α—is the temperature dependent coefficient of thermal expansion;

tₘₐₓ—The maximum temperature across a particular section; and

tₐᵥₑ—is the average temperature of a particular section.

The aforementioned equation may be incorporated into system 10 for calculating the values of the same across each section volume and stores them a program data array. Accordingly, computer system 2 further reduces the computer processing cycle time and saves cost.

Optimization of the internal geometry of the solid model is automatically changed with each iteration until the predicted physical parameter satisfies, matches or a best match occurs of a desired predetermined criteria at steps 142 and 144. A best match occurs within a predetermined tolerance factor or ranges of values. The conditional internal cooling geometry is updated in which, a new internal geometry is created as a function of the previously described geometry variables. Then at step 144, the new internal geometry is provided to the automated geometry of finite element mesh algorithm 102. Then after several iterations, the final geometry and projected life is obtained at step 146. Then the attribute data associated with the final geometry is outputted to display device 24 or other output devices. It should be recognized that Steps 102, 120, 125-146 can be embodied in computer readable code in a program 31 in which optimizer module 10 can initiate commands to execute the steps within computer system 2. This forms an integrated system for radial cooled bucket optimization.

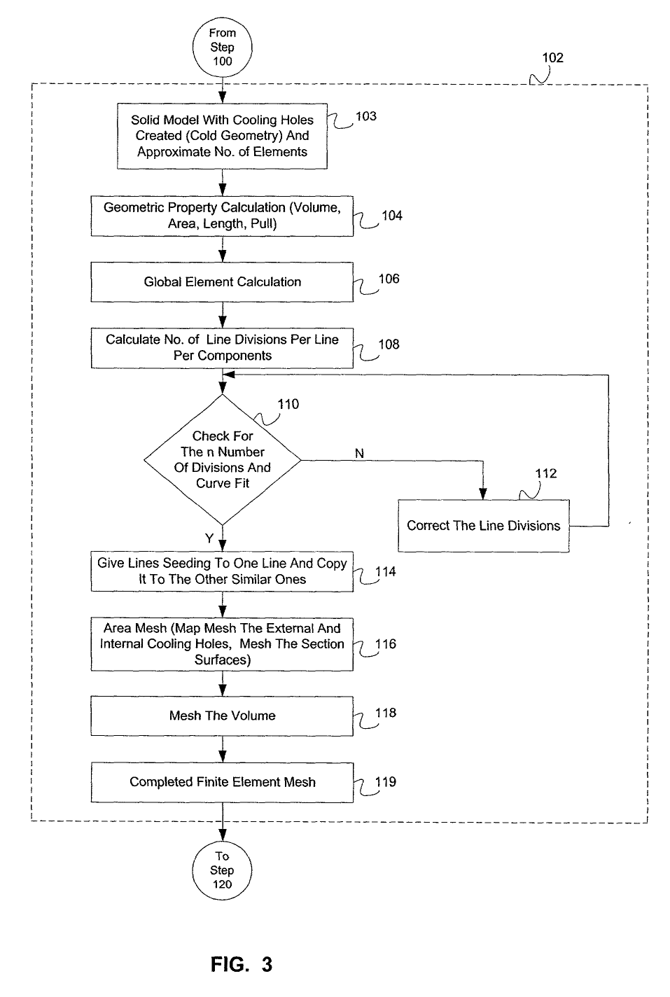

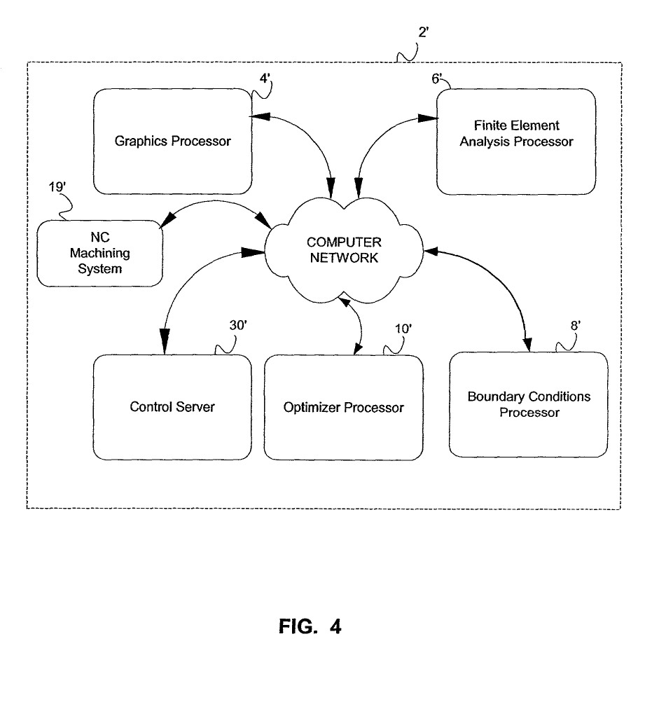

Although computer system 2 is illustrated having a single central processing unit, and a single storage device, it is contemplated that computer system 2 may be equipped with any number of processor or storages devices. In addition, as shown in FIG. 4, a computer system 2′ may be in the form of a distributed network of computers in which the previously described modules 4′, 6′, 8′, 10′, are executed on separate computer processors. A control server 30 coordinates the operations of the modules and output of the various modules are transmitted via the network. The network computer system 2′ embodiment enables large and complex analytical models to be analyzed that may require an intensive amount of computer processing power. Some applications can include performing a simulation of a large portion of a gas turbine and optimizing in situ the assembly of buckets and cooling geometry of each bucket.

With reference to FIGS. 1 and 4, if desired, computer system 2 can be interfaced with a computerized numerical control (CNC) machine tooling system 19, 19′ for drilling or otherwise machining the internal cooling geometry of the radial cooled bucket. With appropriate interfaces, the outputted component attribute data of bucket can be transmitted to CNC machine tooling system 19, 19′ and written CNC computer readable machine code.

It is contemplated that computer system 2 may be modular for integration of one or more modules. For example, an airfoil creation module could be added in which the aforementioned airfoil design and cold or unheated geometry is determined. This output of the airfoil creation module can be transmitted to FEA module 6. In a further arrangement of computer system 2, the full bucket geometry can be reviewed including the attachment/shank and tip or shroud portions of a radial cooled bucket. The respective geometries can be provided to BC module 8 and FEA module 6 in which boundary conditions and finite element meshes can be created and geometry optimized. It should be recognized that the advance cooling hole geometries can be optimized such as shaped and axial forms.

Thus, a computer system and method for three-dimensional radial cooled bucket performance prediction has been described. The computer system and method significantly reduces the engineering cycle time and computational processing time to predict the overall response of a radial cooled bucket. It possible to have reduction in time by nearly 80% to 90%. The computer system can revolutionize the way radial cooled buckets are designed. Different radial cooled geometries can be optimized such that significant performance and life improvements can be determined. For example, if there is a way to improve a trailing edge of buckets from erosion oxidation, the disclosed computer system and method enables accurate and rapid analysis. Various thermal simulations can be quickly performed with different radial passageway configurations and optimization module 10 can determine optimum configuration.

While the invention has been describes with reference to preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiment disclosed, but that the invention will include all embodiments falling within the scope of the appended claims.

### EXAMPLE

An example of the optimization method of computer system of the present invention follows. FIGS. 5-16 illustrate an example of a bucket at various stages processed by computer system 2. In FIG. 5, a three-dimensional solid model 40 of a bucket for a gas turbine engine is created with the graphics module. It should be recognized that the solid model includes certain attribute data. An existing bucket design is used for optimizing the radial cooling geometry. As shown below in Table 1 global data is established for the computer system prediction and optimization of the bucket. The use of the attribute data was explained in the detailed description of the invention.

TABLE 1

| Sample Input Variables | Value |
|---|---|
| Number of Cooling Holes | 16 |
| Number of Sections | 7 |
| Number of Elements | 80,000 |
| Surface element type | Triangular |
| Volume Element type | Tetrahedral |
| Operating Speed of | 3600 |
| Turbine | |
| Material Density | .289 |
| Turbulation | None |

FIG. 6 shows a perspective view of a solid model of the airfoil portion 42 of the bucket. The radial cooling passageways will be formed through this airfoil portion. The automated geometry and a finite element mesh creation agent retrieves data files defining the initial geometry of the radial cooling passageways. The contents of the data file are shown in the Tables 2 and 3. The root position of the center of each of the 16 radial passageways is shown in Table 2. The corresponding airfoil radial tip position of each passageway is shown in Table 3. The data files define the X, Y and Z values of the respective center positions of the 16 radial cooling passageways. The Z values are measured from a predefined engine center.

TABLE 2
Root Positions

| X | Y | Z |
|---|---|---|
| 0.372671 | −1.31923 | 32.35578 |
| 0.15587 | −1.15344 | 32.35578 |
| −0.16437 | −0.92955 | 32.35578 |
| −0.07935 | −0.61214 | 32.35578 |
| −0.42793 | −0.57247 | 32.35578 |
| −0.18563 | −0.17287 | 32.35578 |
| −0.45911 | −0.14595 | 32.35578 |
| −0.14028 | 0.221052 | 32.35578 |
| −0.43927 | 0.352833 | 32.35578 |
| −0.17854 | 0.691496 | 32.35578 |
| 0.07085 | 0.794937 | 32.35578 |
| 0.222469 | 0.942305 | 32.35578 |
| 0.412347 | 1.082588 | 32.35578 |
| 0.605059 | 1.207284 | 32.35578 |
| 0.768014 | 1.306474 | 32.35578 |
| 0.929552 | 1.394328 | 32.35578 |

TABLE 3
Airfoil Radial Tip Positions

| X | Y | Z |
|---|---|---|
| −0.25931 | −0.84737 | 39.26649 |
| −0.40385 | −0.72125 | 39.26649 |
| −0.61073 | −0.61356 | 39.26649 |
| −0.43644 | −0.46053 | 39.26649 |
| −0.76376 | −0.40951 | 39.26649 |
| −0.41376 | −0.21397 | 39.26649 |
| −0.73117 | −0.16154 | 39.26649 |
| −0.3004 | 0.005668 | 39.26649 |
| −0.55263 | 0.022672 | 39.26649 |
| −0.17854 | 0.229554 | 39.26649 |
| 0.18421 | 0.413764 | 39.26649 |
| 0.478946 | 0.546962 | 39.26649 |
| 0.796354 | 0.685828 | 39.26649 |
| 1.075503 | 0.800605 | 39.26649 |
| 1.326312 | 0.902629 | 39.26649 |
| 1.511939 | 0.976313 | 39.26649 |

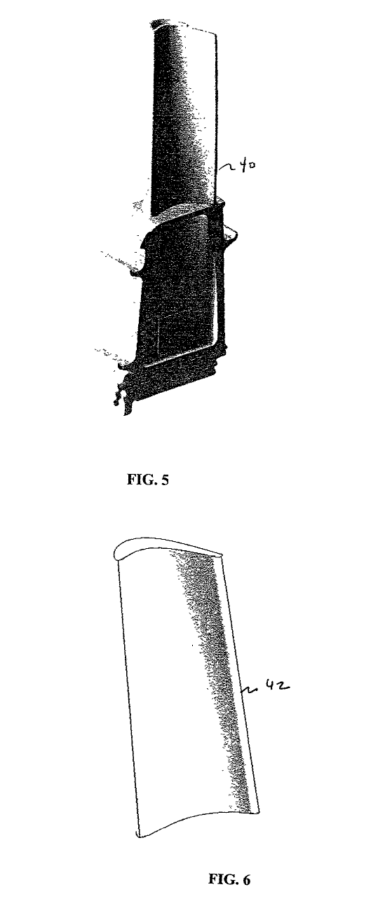

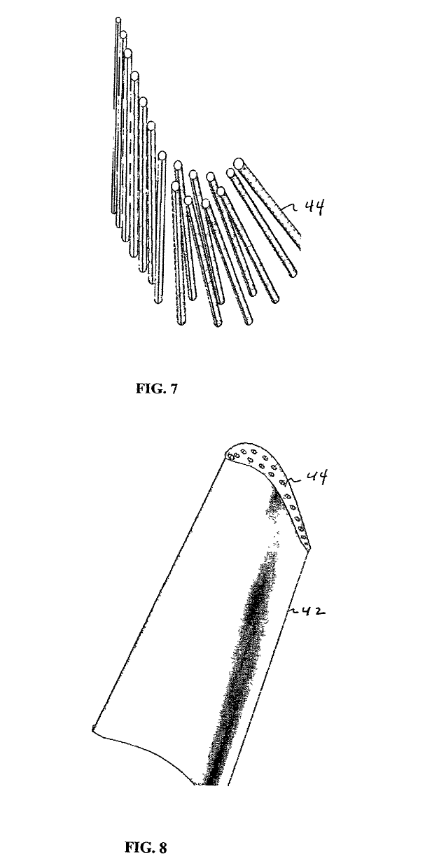

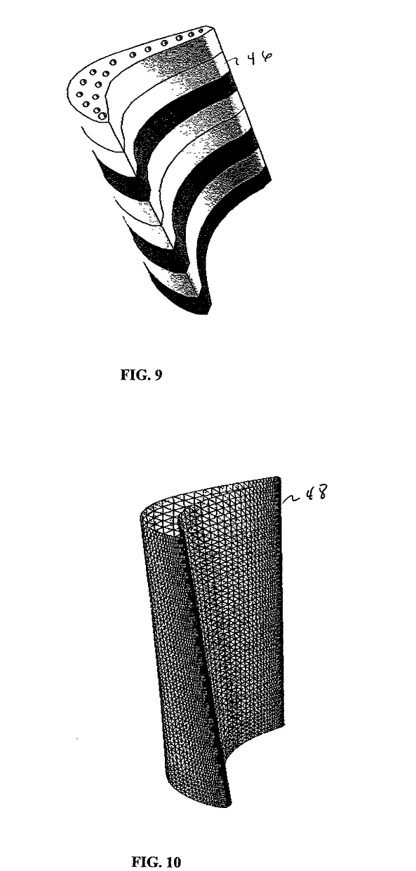

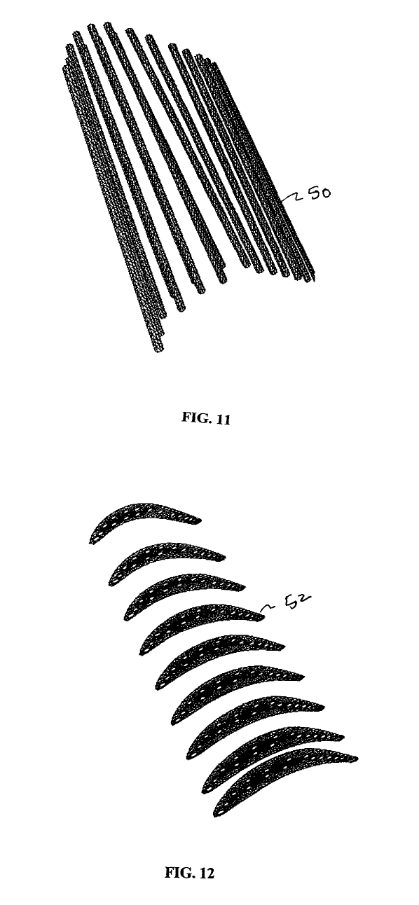

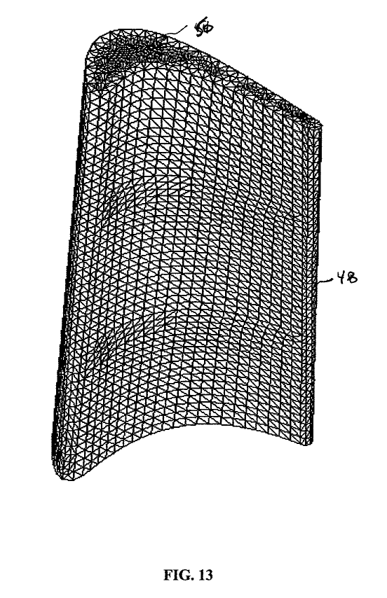

The algorithm creates solid models representing the volume of each of the radial cooling passageways 44 from the data files as shown in FIG. 7. FIG. 8 shows the result of a series of Boolean operations to position the solid models radial cooling passageways within the airfoil solid model. FIG. 9 shows a perspective view of the modeled airfoil shown in FIG. 8 after section volumes 46 have been created according to the teaching of the present invention. Once the airfoil is modeled with section volumes, these solid modeling steps are carried out in finite elements. First, an external finite element mesh 48 of an external surface area of the solid model is then created in FIG. 10. Then, an internal finite element mesh 50 of inside surfaces of the radial cooling passageways is generated in FIG. 11. A finite element mesh of section areas 52 is created in FIG. 12. Finally, as shown in FIG. 13, external finite element mesh containing the internal volume mesh is formed. The entire solid modeling geometry and finite element mesh generation is automatically executed by computer system 2 in accordance with the previously described computer system and method.

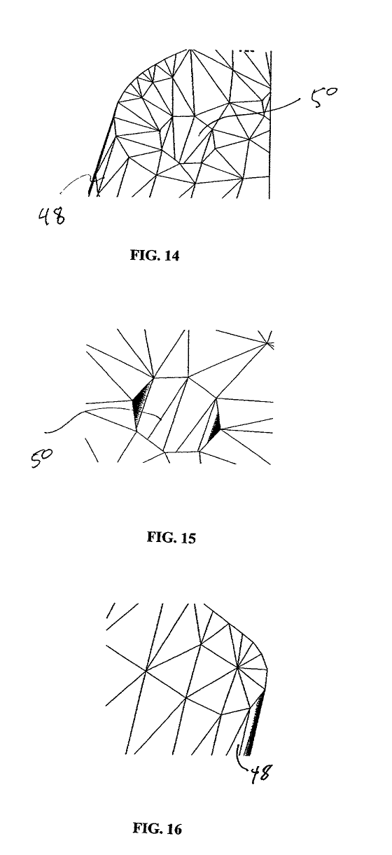

FIGS. 14-16 illustrates an exemplary view of the finite element mesh at the radial airfoil tip of the solid model. As can be seen in FIGS. 14 and 15, the adaptive curve fitting technique implemented in the computer system forms a good cross-sectional shape of the cooling passageways. Also as shown in FIG. 16, the triangular elements form a close approximation of the solid model geometry.

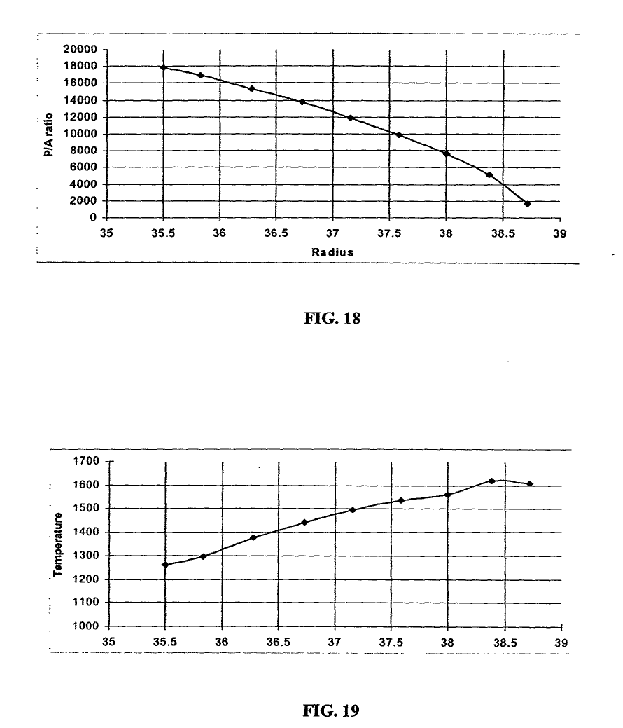

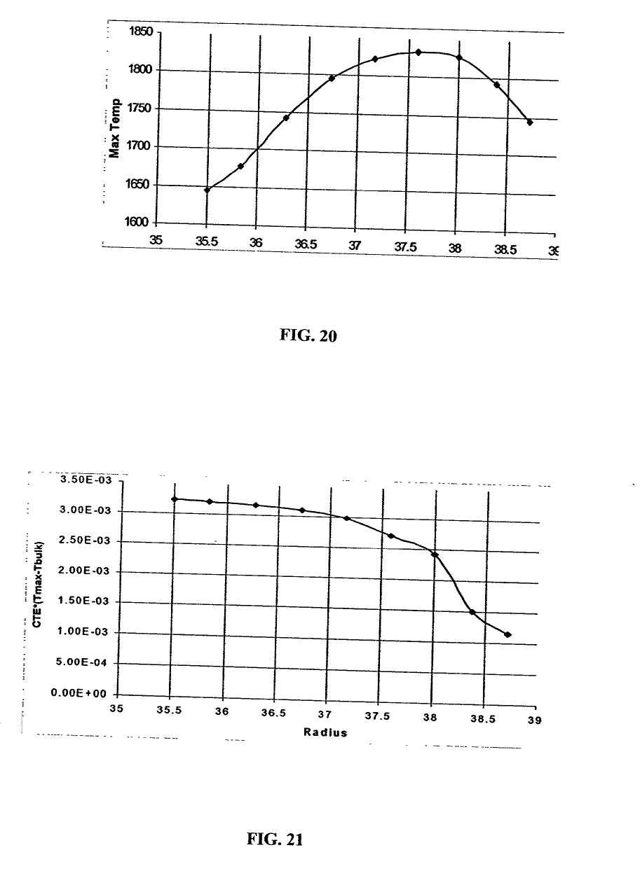

The results of the heat transfer simulation are shown in FIGS. 18-21. The results are presented in terms of the section volumes. The data points are selected by going from the root portion of airfoil to the airfoil radial tip. In general, the creep life is a function of the axial pull load and the temperature at which it is being held. The pull load and the temperature are stored from the model and that can be used for the estimation of the creep life, in other words the creep life will be more if the load is less for a constant temperature. The oxidation capability of the bucket is a function on the maximum temperature and the bucket. Then, the optimizer module determined the final internal cooling geometry as described.

What is claimed is:

1. A computer system for determining an internal cooling geometry of a bucket for a turbine engine, the internal cooling geometry being defined by a plurality of geometry variables, the computer system comprising:
a simulation module for forming a model of the bucket having the internal cooling geometry, and executing a simulation of a thermal environment within the turbine engine, and outputting a performance parameter being predicted for the bucket based on the model; and
an optimizer for comparing the performance parameter with respect to a baseline criterion and for automatically modifying at least one geometry variable for the internal cooling geometry of the bucket for outputting a plurality of attribute data of the internal cooling geometry.

2. The computer system of claim 1, wherein the simulation module further comprises a finite element analysis module and a finite element mesh generator.

3. The computer system of claim 2, wherein the model further comprises a finite element mesh of an internal geometry and an external geometry of a solid model based on the bucket.

4. The computer system of claim 3, further comprising a boundary condition processor for defining the simulated thermal environment within the turbine engine.

5. The computer system of claim 4, wherein the boundary condition processor outputs a set of boundary conditions for the model being logically mapped to the finite element mesh of the internal and external geometry of the solid model.

6. The computer system of claim 5, further comprising a control server for operating with the simulation module, the optimizer, and the boundary condition processor.

7. The computer system of claim 1, wherein the simulation module further comprises a finite element analysis module and a finite element mesh generator for generating the model based on a solid model of the bucket.

8. The computer system of claim 7, further comprising an agent for cooperating with the simulation module and the optimizer to create the internal cooling geometry of the solid model for the bucket.

9. The computer system of claim 8, wherein the agent calculates a plurality of geometric properties of the solid model, and calculates a global finite element size for creating the finite element mesh, approximates the internal cooling geometry of the bucket with adaptive curve fitting, and cooperates with the finite element mesh generator to create a finite element mesh of the internal cooling geometry.

10. The computer system of claim 1, further comprising a controller operating on a computer network coordinating the simulation module and the optimizer.

11. A computer system for optimizing a radial cooled bucket for a turbine engine, the system comprising;
a simulator for processing an analytical model of the radial cooled bucket being defined by an external geometry and a cooling geometry, the analytical model having a plurality of external boundary conditions and internal boundary conditions, and the simulator using finite element thermal analysis and outputting at least one performance parameter based on analytical model;
an optimizer for comparing the performance parameter to a baseline parameter to determine attribute data of an internal cooling geometry of the radial cooled bucket; and
a program in computer readable code for controlling the operation of the simulator and the optimizer until the attribute data is determined, such that the program continually modifies the cooling geometry to create a modified analytical model such that the simulator processes the modified analytical model having the external boundary conditions and a plurality of modified internal boundary conditions linked to a modified cooling geometry.

12. The computer system of claim 11, further comprising a finite element mesh generator.

13. The computer system of claim 12, further comprising a boundary condition generator for defining a simulated thermal environment within the turbine engine.

14. The computer system of claim 13, further comprising a graphics processor for generating a solid model of the radial cooled bucket for the turbine engine.

15. The computer system of claim 14, further comprising an agent cooperating with the simulator for creating the cooling geometry and modified cooling geometry of the radial cooled bucket.

16. A computer system for determining an internal heat exchanging geometry of a bucket for a turbine engine, the computer system comprising:
means for generating a model of the bucket having an internal cooling geometry;
means for simulating a thermal environment within the turbine engine using the model and for outputting a performance parameter being predicted for the bucket based on the model; and
means for optimizing the performance parameter with respect to a baseline parameter and for modifying at least one variable for the internal cooling geometry of the bucket for outputting a plurality of attribute data of the internal cooling geometry.

17. The computer system of claim 16, further comprising a means for generating a solid model geometry of the bucket.

18. The computer system of claim 17, wherein the means for simulating further comprises a means for processing the model using finite element analysis.

19. The computer system of claim 18, further comprising means for creating and mapping boundary conditions for the model.

20. The computer system of claim 19, further comprising means for automatically creating the internal cooling geometry of the model of the bucket.

21. The computer system of claim 20, further comprising means for controlling the means for simulating and the means for optimizing

22. A method of computer processing airfoil attribute data of a radial cooled bucket for a turbine engine, the method comprising the steps of:
a) providing a model based on the attribute data of the radial cooled bucket, the model having an external finite element geometry and an internal finite element geometry;
b) mapping a plurality of external boundary conditions to the external finite element geometry;
c) mapping a plurality of internal boundary conditions to the internal finite element geometry;
d) simulating, in a heat transfer analysis, a predicted response of the radial cooled bucket based on the model having the set of external boundary conditions and the set of internal boundary conditions;
e) optimizing the internal finite element geometry by comparing the predicted physical response to a predetermined baseline to determine a best match; and
f) modifying the internal finite element geometry of the model and the set of internal boundary conditions in response to step e);
g) repeating steps b) through f) until a best match occurs; and
h) in response to the best match, outputting the attribute data associated with the modified internal finite element geometry.

23. The method of claim 16, further comprising the step of calculating a plurality of geometric properties of the model.

24. The method of claim 17, further comprising the step of calculating a finite element size for creating the external finite element geometry and an internal finite element geometry.

25. The method of claim 18, further comprising the step of approximating the internal finite element geometry by adaptive curve fitting.

26. The method of claim 16, further comprising the step of transmitting the attribute data to a numerical control machining system.

27. A computer readable medium having a program for evaluating attribute data of a radial cooled bucket for a turbine engine, comprising the steps of:
a) providing a model the radial cooled bucket, the model having an external finite element geometry and an internal finite element geometry;
b) simulating, in a heat transfer analysis, a predicted response of the radial cooled bucket based on the model having a plurality of external boundary conditions and a plurality of internal boundary conditions;
c) optimizing the internal finite element geometry by comparing the predicted physical response to a predetermined baseline; and
d) modifying the internal finite element geometry of the model and the internal boundary conditions in response to step c);
e) repeating steps b) through d) until an optimum radial cooled bucket is determined; and
f) outputting the attribute data upon determining the optimum radial cooled bucket.

28. A method of optimizing a radial cooled bucket of a turbine engine implemented on the computer processing system comprising the steps of:
a) receiving a solid model geometry of a bucket to the finite element analysis module, the solid model geometry having an external geometry;
b) storing the boundary conditions of the external geometry;
c) creating an internal cooling geometry of the solid model geometry and a finite element mesh of the internal cooling geometry, and generating boundary conditions of the internal cooling geometry, and creating a finite element mesh of the external geometry;
d) mapping the boundary conditions to the finite element mesh of the internal cooling geometry and the external geometry to create a bounded finite element mesh;
e) executing a finite element heat transfer analysis on the bounded finite element mesh to produce a plurality of performance parameters;
f) comparing the plurality of performance parameters to a baseline criteria to optimize the internal cooling geometry of the solid model;
g) responsive to step f), if the plurality of performance parameters and the baseline criteria does not match, updating the internal cooling geometry of the solid model; and
h) repeating steps c) through g) until the plurality of the performance parameters and the baseline criteria match.

29. A bucket of a turbine engine designed in accordance with a method of optimizing a radial cooled bucket of a turbine engine implemented on the computer processing system comprising the steps of:
a) providing a solid model geometry of a bucket to the finite element analysis module, the solid model geometry having external geometry;
b) storing the boundary conditions of the external geometry;
c) creating an internal cooling geometry of the solid model geometry and a finite element mesh of the internal cooling geometry, and generating boundary conditions of the internal cooling geometry, and creating a finite element mesh of the external geometry of the solid model;
d) mapping the boundary conditions to the finite element mesh of the internal cooling geometry and external geometry;
e) executing a finite element heat transfer analysis on the bounded finite element mesh to produce a plurality of performance parameters;
f) comparing the plurality of performance parameters to a baseline criteria to optimize the internal cooling geometry of the solid model;
g) responsive to step f), if the plurality of performance parameters and the baseline criteria does not match, updating the internal cooling geometry of the solid model; and
repeating steps c) through g) until the plurality of the performance parameters and the baseline criteria match.
